(19) United States
(12) Patent Application Publication
(10) Pub. No.: US 2016/0113229 A1
(43) Pub. Date: Apr. 28, 2016

(54) Adjustable Animal Gate

(71) Applicants: Daniel Lee Porter, Collbran, CO (US); Margie Lucille Porter, Collbran, CO (US)

(72) Inventors: Daniel Lee Porter, Collbran, CO (US); Margie Lucille Porter, Collbran, CO (US)

(21) Appl. No.: 14/522,236

(22) Filed: Oct. 23, 2014

(51) Int. Cl. A01K 1/00; E06B 11/02; A01K 1/02

(52) U.S. Cl. CPC A01K 1/0023; A01K 1/0218; A01K 1/0029; E06B 11/02

(57) ABSTRACT

A livestock gate includes a plurality of retractable horizontal members to create a variable height opening in the gate. The variable height opening allows animals below a particular height to pass through while restricting larger animals. While weaning, young animals are permitted to pass through the variable height opening to reach feed while cows are excluded to prevent nursing and competition from the larger animals.

### FIELD OF THE INVENTION

The present invention is directed generally toward livestock and animal gates.

### BACKGROUND

When raising livestock, such as horses, pigs, sheep, goats or other animals, weaning can be a traumatic period resulting in high stress and weight loss while learning to eat from a feed bunk. Young animals need access to feed without competitive feeding from the parent animals. Young animals also need to be conditioned for separation from the parent animal and to socialize with other young animals.

Young animals may be removed from the parent animals, but such separation may cause further stress. Existing systems for allowing young animals access to feed include heavy, cumbersome feeders that require heavy equipment to move.

Consequently, it would be advantageous if an apparatus existed that is suitable for segregating animals by size to facilitate weaning.

### SUMMARY

Accordingly, the present invention is directed to a novel apparatus for segregating animals by size to facilitate weaning.

In one embodiment of the present invention, a livestock gate includes a plurality of retractable horizontal members to create a variable height opening in the gate. The variable height opening allows animals below a particular height to pass through while restricting larger animals. In one implementation, while weaning young animals, young animals are permitted to pass through the variable height opening to reach feed while cows are excluded to prevent nursing.

In another embodiment, horizontal support sections may be removed to create a variable width opening. A variable width opening allows several young animals to pass through. Alternatively, horizontal supports may be spaced more closely together without sacrificing the advantages of a variable height opening.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous advantages of the present invention may be better understood by those skilled in the art by reference to the accompanying figures in which:

FIG. 1 shows an environmental view of a livestock gate according to one embodiment of the present invention;

FIG. 2 shows a front view of a livestock gate according to one embodiment of the present invention;

FIG. 3 shows a perspective view of a livestock gate according to one embodiment of the present invention;

FIG. 4 shows a perspective detailed view of a portion of a livestock gate according to one embodiment of the present invention;

FIG. 5 shows a perspective detailed view of a latching mechanism useful in one embodiment of the present invention;

FIG. 6 shows a front detailed view of a latching mechanism and rotation mechanism for a horizontal member according to one embodiment of the present invention;

FIG. 7 shows a front detailed view of an alternative embodiment of a horizontal member according to one embodiment of the present invention;

FIG. 8 shows a perspective view of a livestock gate according to another embodiment of the present invention;

FIG. 9 shows a perspective detailed view of a portion of a livestock gate according to one embodiment of the present invention;

### DETAILED DESCRIPTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

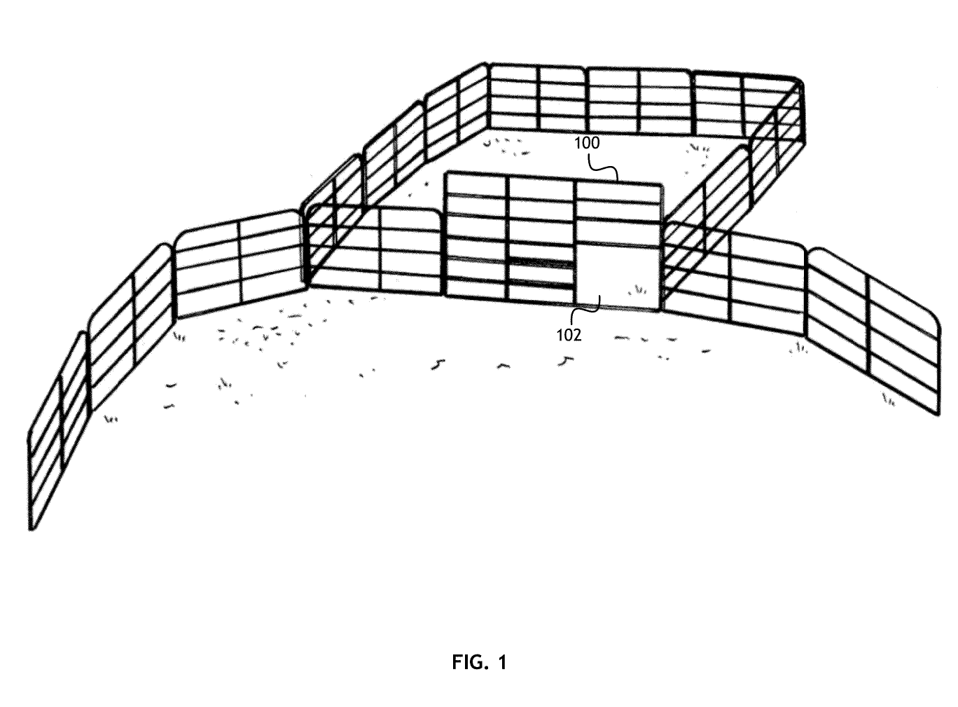

Referring to FIG. 1, an environmental view of a livestock gate according to one embodiment of the present invention is shown. In at least one embodiment, a pen or coral may include a gate 100 comprising a primary frame structure, one or more vertical rails and horizontal rails that can be moved to create a variable height opening 102 in the gate 100. The gate 100 may allow young animals access to an enclosure including a feeding bunk specifically designated for the young animals such that the young animals may feed without competition from larger cows, but still allowing the cows to remain in the vicinity, reducing stress on the young animals.

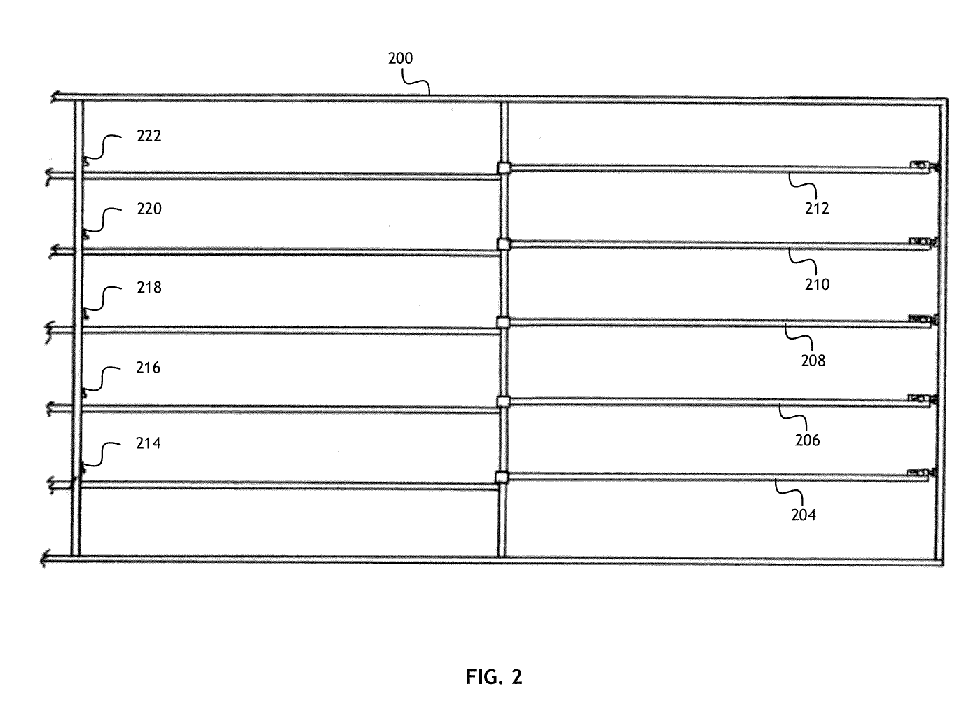

Referring to FIG. 2, a front view of a livestock gate 200 according to one embodiment of the present invention is shown. The gate 200 may include a plurality of horizontal rails 204, 206, 208, 210, 212; each of the horizontal rails 204, 206, 208, 210, 212 may be repositioned to allow a variable height opening in the gate 200. In one embodiment, each horizontal rail 204, 206, 208, 210, 212 may pivot around a common vertical rail. Each horizontal rail 204, 206, 208, 210, 212 may be secured to a corresponding connection point 214, 216, 218, 220, 222 in an opposing vertical rail.

In another embodiment of the present invention, each horizontal rail 204, 206, 208, 210, 212 may slide past the common vertical rail to be secured to a corresponding connection point 214, 216, 218, 220, 222 in an opposing vertical rail.

The horizontal rails 204, 206, 208, 210, 212 may be rotated or retracted in sequence from the ground up until an opening of a desired height is produced. The height of the opening may be based on the height of young animals that will be using the opening.

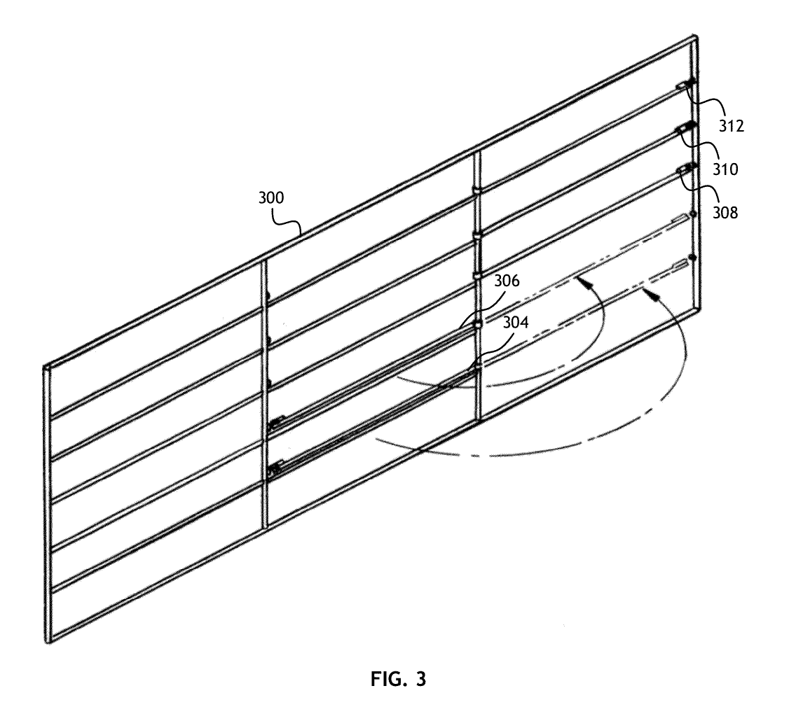

Referring to FIG. 3, a perspective view of a livestock gate 300 according to one embodiment of the present invention is shown. A first horizontal rail 304 and second horizontal rail 306 are pivoted around a common vertical rail and secured in an opened position while a third horizontal rail 308, fourth horizontal rail 310 and fifth horizontal rail 312 are left in a closed position creating an opening in the gate suitable for young animals. Furthermore, when desirable, the first horizontal rail 304 and second horizontal rail 306 are pivoted closed.

Using the gate adjusted to the right height allows calves at an early age to enter a feed area for extra nutrition and return to an outside area with the parent animals close by. Once the young animals adjust to the separation process, the horizontal rails may be closed and the parent animals moved away. A gate according to embodiments of the present invention may be operative for all livestock by adjusting the size of the opening.

Furthermore, a gate according to the present invention may be useful where the gate is obstructed. If snow has drifted or piled up, or if mud or manure has accumulated, the bottom most horizontal rails may be opened so that the adjustable height opening may be used regardless of such obstructions without immediately shoveling or otherwise forcing the gate open.

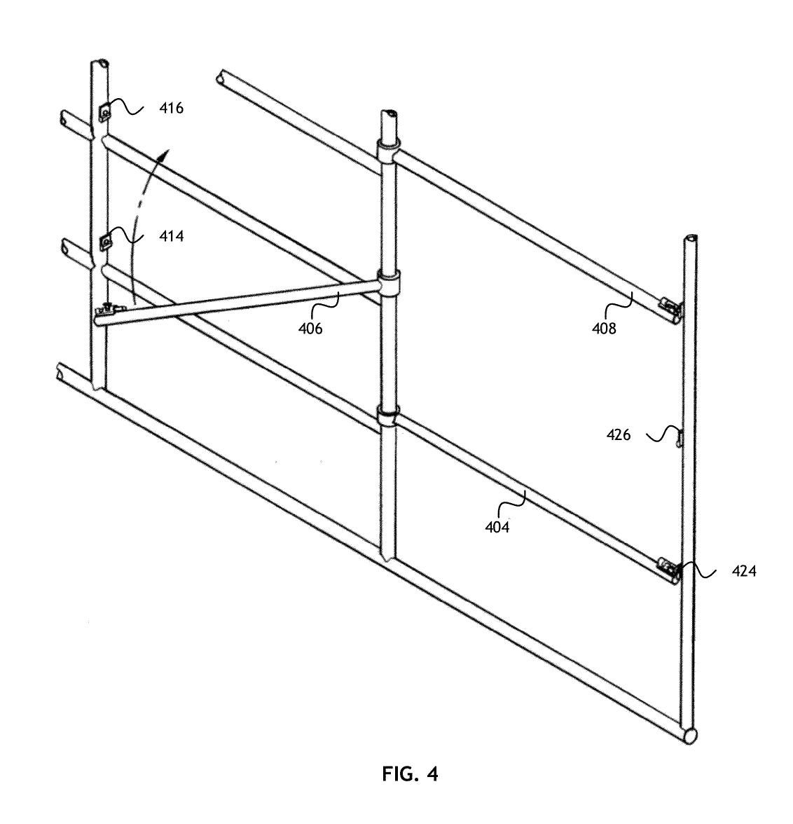

Referring to FIG. 4, a perspective detailed view of a portion of a livestock gate, such as shown in FIG. 3, according to one embodiment of the present invention is shown. Where a livestock gate includes a plurality of horizontal rails 404, 406, 408 according to embodiments of the present invention, each horizontal rail 404, 406, 408 may be independently moved from a closed position (such as shown by the first horizontal rail 404 and third horizontal rail 408). The closed horizontal rails 404, 408 may be latched in a closed position by engaging a latching mechanism into a corresponding closed position keeper mechanism 426, 424 in a first vertical rail. Furthermore, each horizontal rail 404, 406, 408 may be independently moved from a closed position to an opened position (such as shown by the second horizontal rail 406) by disengaging the latch associate with the such horizontal rail 406, re-orienting the horizontal rail 406 and engaging the latching mechanism into a corresponding opened position keeper mechanism 416 in a second vertical rail.

In one embodiment, the horizontal rails 404, 406, 408 may pivot around a common vertical rail such that a single latching mechanism on each horizontal rail 404, 406, 408 may engage both a closed position keeper mechanism 426 and an opened position keeper mechanism 416. In another embodiment, each horizontal rail 404, 406, 408 may slide horizontally from a closed position, where a first latching mechanism engages the closed position keeper mechanism 426, to an opened position, where a second latching mechanism engages the opened position keeper mechanism 416. In such an embodiment, the common vertical rail may include a horizontal rail retention element corresponding to each horizontal rail 404, 406, 408, such that each horizontal rail 404, 406, 408 is maintained along a desired path to slide from a closed to an opened position.

While FIG. 4 shows an embodiment wherein the second horizontal rail 406 is in the process of being re-oriented to an opened position, in some embodiments, horizontal rails 404, 406, 408 may be opened from the bottom up (from the first horizontal rail 404 to the second horizontal rail 406 to the third horizontal rail 408) until an opening of a desired size is produced. Alternatively, lowermost horizontal rails 404, 406, 408 that are obstructed may be left in a closed position as necessary.

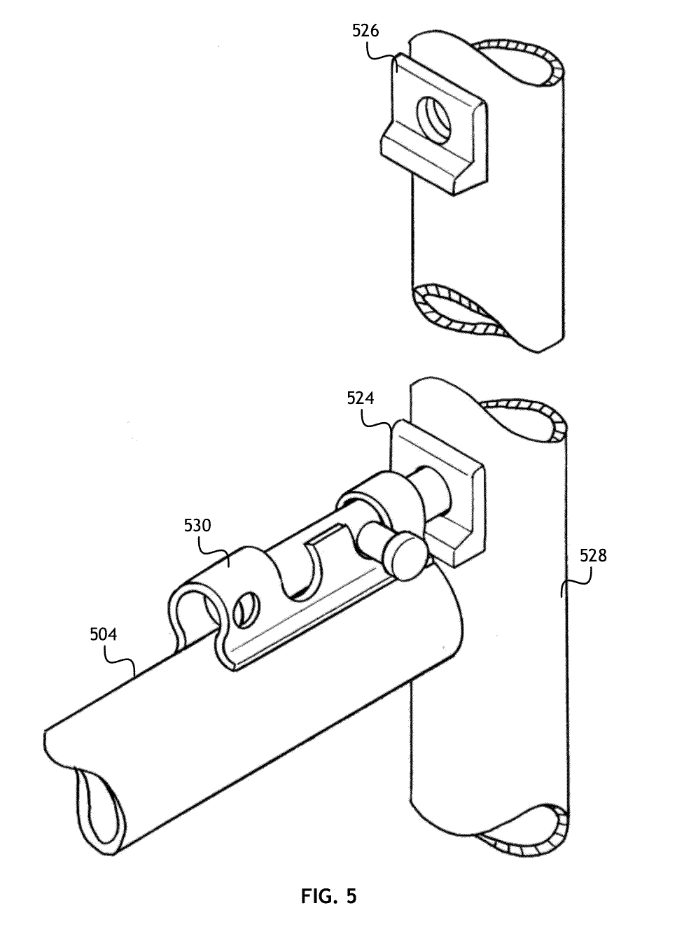

Referring to FIG. 5, a perspective detailed view of a latching mechanism useful in one embodiment of the present invention is shown. A horizontal rail 504 may comprise a latching mechanism 530 such as a bolt action pin configured to engage a corresponding keeper mechanism 524. Keeper mechanisms 524, 526 may be configured to hold the horizontal rails 504 in either an opened position or a closed position. Each keeper mechanism 524, 526 is housed in a vertical rail 528.

While a bolt action pin latching mechanism 530 is shown, other types of latching mechanisms are envisioned, such as a spring actuated bolt. A spring actuated latching mechanism may be configured to retract when engaging a keeper mechanism 524, 526 from either direction where the spring actuated latching mechanism is affixed to a horizontal rail 504 designed to pivot about a common vertical rail because the spring actuated latching mechanism will approach the opened position keeper mechanism and closed position keeper mechanism from different sides.

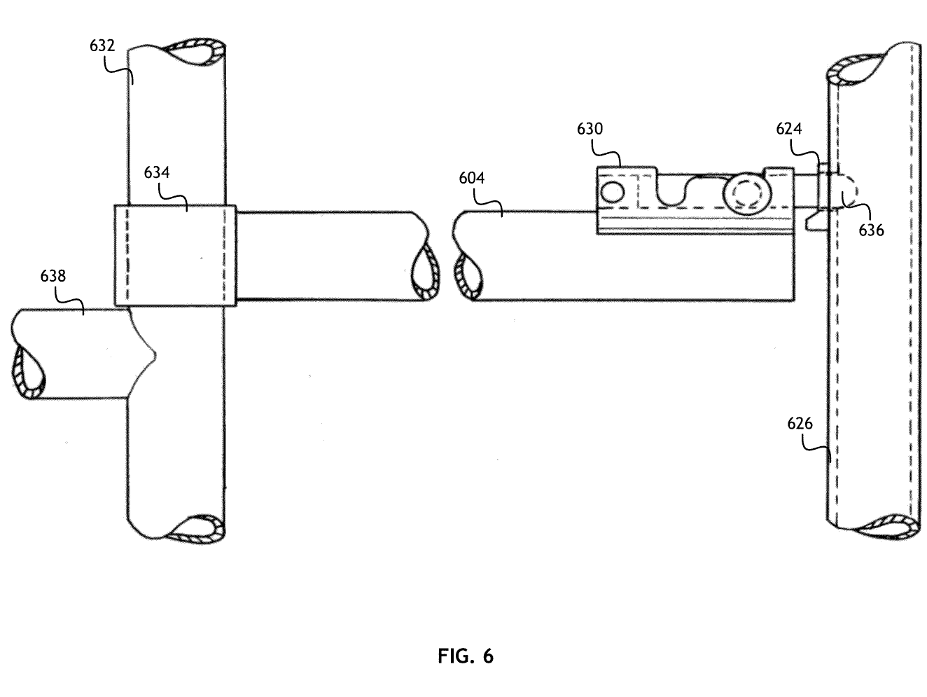

Referring to FIG. 6, a front detailed view of a latching mechanism and rotation mechanism for a horizontal member according to one embodiment of the present invention is shown. Where a horizontal rail 604 is configured to pivot about a common vertical rail 632, the horizontal rail 604 may include a common vertical rail collar 634 that pivots about the common vertical rail 632. The common vertical rail collar 634 rests upon a corresponding horizontal support rail 638. The horizontal rail 604 is fully supported by the horizontal support rail 638 and a latch bolt 636 of a latch mechanism 630 engaging a corresponding keeper mechanism 624. While FIG. 6 shows a livestock gate according to the present invention in a closed position, substantially similar mechanisms are also operable to maintain the horizontal rail 604 in an opened position.

While embodiments of the present invention herein described specifically refer to livestock, alternative embodiments may be useful for other applications. In one embodiment, small pets such as puppies or kittens may be separated from their mother. Likewise, kennels, breeders or veterinarians may utilize gates according to embodiments of the present invention, though potentially on a smaller scale than the specific embodiments described herein.

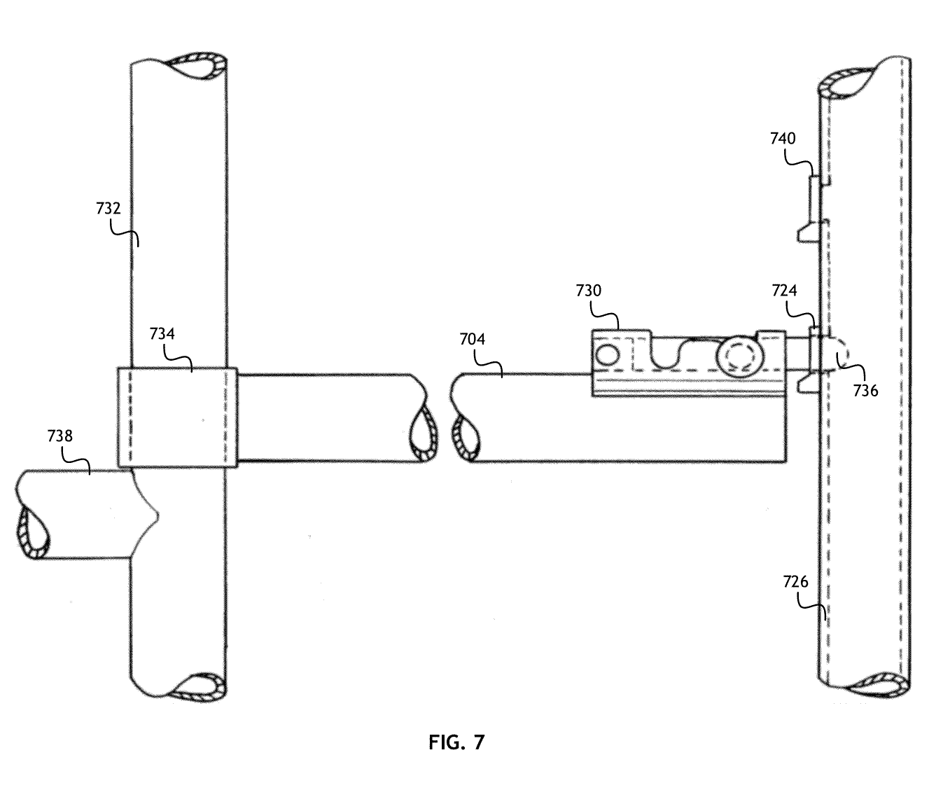

Referring to FIG. 7, a front detailed view of an alternative embodiment of a horizontal member according to one embodiment of the present invention is shown. Where a horizontal rail 704 is configured to pivot about a common vertical rail 732, the horizontal rail 704 may include a common vertical rail collar 734 that pivots about the common vertical rail 732 and in at least one embodiment, the vertical rail collar 734 may slide up and down along the common vertical rail 732. At different points along the common vertical rail 732, a latch bolt 736 of a latch mechanism 730 engages one of a plurality of corresponding keeper mechanisms 724, 740. Multiple keeper mechanisms 724, 740 allow for additional fine adjustments to the height of the adjustable height opening.

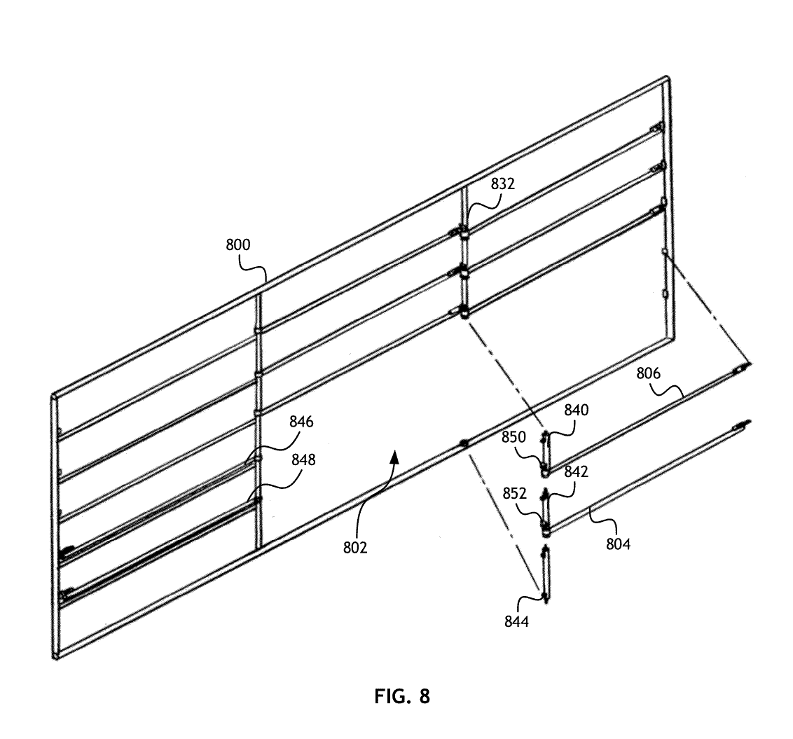

Referring to FIG. 8, a perspective view of a livestock gate according to another embodiment of the present invention is shown. A first horizontal rail 804 pivots around a first detachable vertical rail segment 840 and the second horizontal rail 806 pivots around a second detachable vertical rail segment 842. Both the first detachable vertical rail segment 840 and second detachable vertical rail segment 842 may releasably engage with a one or more additional vertical rail segments or a common vertical rail segment to form a vertical rail that defines a boundary of a variable width/variable height opening 802. Each of the first detachable vertical rail segment 840 and second detachable vertical rail segment 842 may include latch keeper mechanisms 850, 852 configured to engage latching mechanisms associated with one of a third horizontal rail 846 and a forth horizontal rail 848. In the embodiment shown in FIG. 8, the third horizontal rail 846 and fourth horizontal rail 848 are configured to pivot around a second common vertical rail in a manner substantially similar to that described herein. The addition of the third horizontal rail 846 and fourth horizontal rail 848, in conjunction with releasable vertical rail segments 840, 842, 844, allow for a variable width opening 802 that may double in size to accommodate young animals moving abreast to pass through. Furthermore, the third horizontal rail 846 and fourth horizontal rail 848 may be operated independently of the first horizontal rail 804 and second horizontal rail 806 to create a variable height opening in a different portion of the livestock gate 800 if desired.

Vertical rail segments 840, 842, 844 may be configured to interlock by any appropriate means, such as interlocking threaded elements in distal ends of each vertical rail segment 840, 842, 844, and in at least a bottom portion of a common vertical rail 832.

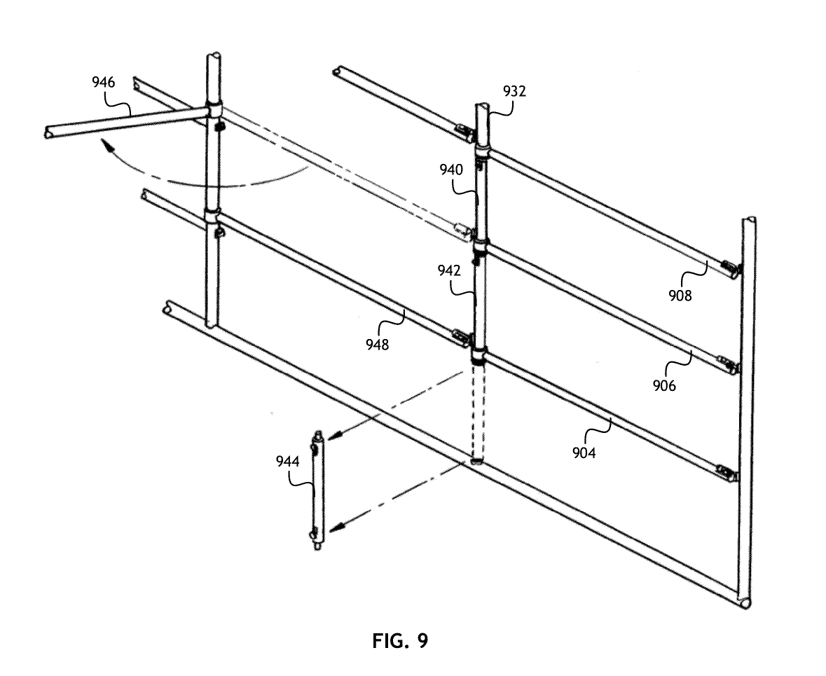

Referring to FIG. 9, a perspective detailed view of a portion of a livestock gate according to one embodiment of the present invention is shown. Where a livestock gate, such as shown in FIG. 8, includes a plurality of horizontal rails 904, 906, 908, 946, 948 according to embodiments of the present invention, each horizontal rail 904, 906, 908, 946, 948 may be independently moved from a closed position (such as shown by the first horizontal rail 904, second horizontal rail 906, third horizontal rail 908 and fourth horizontal rail 946). Horizontal rails 904, 906, 908, 946, 948 may be divided into a first grouping defining a first variable height opening, such as the first horizontal rail 904, second horizontal rail 906 and third horizontal rail 908, and a second grouping defining a second variable height opening, such as the fourth horizontal rail 946 and fifth horizontal rail 948.

Either the first grouping or the second grouping may be moved from a closed position to an opened position as described herein. Furthermore, one or more second grouping horizontal rails 946, 948 may be moved from a closed position to an opened position, and one or more vertical rail segments 944, 940, 942 corresponding to those second grouping horizontal rails 946, 948 may be disengaged from a common vertical rail 932 and removed, along with one or more associated first grouping horizontal rails 904, 906, 908 to create a variable height/variable width opening.

In one embodiment, the horizontal rails 904, 906, 908 may pivot around a common vertical rail such that a single latching mechanism on each horizontal rail 904, 906, 908 may engage both a closed position keeper mechanism 926 and an opened position keeper mechanism 916. In another embodiment, each horizontal rail 904, 906, 908 may slide horizontally from a closed position, where a first latching mechanism engages the closed position keeper mechanism 926, to an opened position, where a second latching mechanism engages the opened position keeper mechanism 916. In such an embodiment, the common vertical rail may include a horizontal rail retention element corresponding to each horizontal rail 904, 906, 908, such that each horizontal rail 904, 906, 908 is maintained along a desired path to slide from a closed to an opened position.

Embodiments of the present invention are useful to facilitate weaning of young animals, encouraging socialization of young animals, implementing training methods for young animals and segregating animals for kennels, breeders or veterinarians.

It is believed that the present invention and many of its attendant advantages will be understood by the foregoing description of embodiments of the present invention, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A animal segregation gate comprising:
a frame structure;
one or more vertical rails, at least one of the one or more vertical rails comprising a common vertical rail;
a plurality of horizontal rails, each of the plurality of horizontal rails having both a closed position and an opened position relative to the frame structure,
wherein each of the plurality of horizontal rails is independently re-orientable from the closed position to the opened position.

2. The animal segregation gate of claim 1, wherein each of the plurality of horizontal rails comprises a collar configured to engage the common vertical rail, and wherein each of the plurality of horizontal rails is configured to pivot about the common vertical rail via the collar.

3. The animal segregation gate of claim 2, wherein:
each of the plurality of horizontal rails further comprises a latching mechanism; and
the frame structure comprises a plurality of closed position keeper mechanisms, each configured to engage one of the latching mechanisms to maintain a horizontal rail in a closed position.

4. The animal segregation gate of claim 3, wherein the latching mechanism comprises a spring actuated bolt.

5. The animal segregation gate of claim 3, wherein the frame structure further comprises a plurality of opened position keeper mechanisms, each configured to engage one of the latching mechanisms to maintain a horizontal rail in an opened position.

6. The animal segregation gate of claim 3, wherein one of the one or more vertical rails comprises a plurality of opened position keeper mechanisms, each configured to engage one of the latching mechanisms to maintain a horizontal rail in an opened position.

7. The animal segregation gate of claim 1, wherein the common vertical rail comprises a plurality of horizontal rail slide openings, each configured to allow one of the plurality of horizontal rails to slide laterally from the closed position to the opened position.

8. A livestock pen comprising:
an enclosure for providing feed to young animals; and
a gate for restricting access to the enclosure to animals below a desired height comprising:
a frame structure;
one or more vertical rails, at least one of the one or more vertical rails comprising a common vertical rail;
a plurality of horizontal rails, each of the plurality of horizontal rails having both a closed position and an opened position relative to the frame structure,
wherein each of the plurality of horizontal rails is independently re-orientable from the closed position to the opened position.

9. The livestock pen of claim 8, wherein each of the plurality of horizontal rails comprises a collar configured to engage the common vertical rail, and wherein each of the plurality of horizontal rails is configured to pivot about the common vertical rail via the collar.

10. The livestock pen of claim 9, wherein:
each of the plurality of horizontal rails further comprises a latching mechanism; and
the frame structure comprises a plurality of closed position keeper mechanisms, each configured to engage one of the latching mechanisms to maintain a horizontal rail in a closed position.

11. The livestock pen of claim 10, wherein the latching mechanism comprises a slide bolt.

12. The livestock pen of claim 10, wherein the frame structure further comprises a plurality of opened position keeper mechanisms, each configured to engage one of the latching mechanisms to maintain a horizontal rail in an opened position.

13. The livestock pen of claim 10, wherein one of the one or more vertical rails comprises a plurality of opened position keeper mechanisms, each configured to engage one of the latching mechanisms to maintain a horizontal rail in an opened position.

14. The livestock pen of claim 8, wherein the common vertical rail comprises a plurality of horizontal rail slide openings, each configured to allow one of the plurality of horizontal rails to slide laterally from the closed position to the opened position.

15. A livestock gate comprising:
a frame structure;
a vertical rail comprising a plurality of vertical rail segments, each of the plurality of vertical rail segments configured to releasably interlock;
a common vertical rail;
a plurality of removable horizontal rails, each of the plurality of horizontal rails associated with one of the plurality of vertical rail segments, and each of the plurality of removable horizontal rails having both a closed position and an opened position relative to the frame structure; and
a plurality of horizontal rails, each of the plurality of horizontal rails having a closed position and an opened position relative to one of the plurality of vertical rail segments,
wherein each of the plurality of horizontal rails and removable horizontal rails is independently re-orientable from the closed position to the opened position.

16. The livestock gate of claim 15, wherein each of the plurality of horizontal rails comprises a collar configured to engage the common vertical rail, and wherein each of the plurality of horizontal rails is configured to pivot about the common vertical rail via the collar.

17. The livestock gate of claim 16, wherein:
each of the plurality of horizontal rails further comprises a latching mechanism; and
each of the vertical rail segments comprises a closed position keeper mechanism, each configured to engage one of the latching mechanisms to maintain a horizontal rail in a closed position.

18. The livestock gate of claim 17, wherein the frame structure further comprises a plurality of opened position keeper mechanisms, each configured to engage one of the latching mechanisms to maintain a horizontal rail in an opened position.

19. The livestock gate of claim 17, wherein the common vertical rail comprises a plurality of keeper mechanisms, each configured to engage a latching mechanism on one of the plurality of removable horizontal rails.

20. The livestock gate of claim 15, wherein the horizontal rails are configured to be placed in the opened position and the removable horizontal rails are configured to be placed into the opened position or removed to create a variable width and variable height opening suitable for animals smaller than a particular size.
